(19) United States
(12) Patent Application Publication
(10) Pub. No.: US 2025/0006988 A1
(43) Pub. Date: Jan. 2, 2025

(54) SLURRIES CONTAINING A SOLID ELECTROLYTE AND METHODS OF MAKING THE SAME

(71) Applicant: Solid Power Operating, Inc., Louisville, CO (US)

(72) Inventors: James BERGMAN, Arvada, CO (US); Morgan Morroni, Denver, CO (US); Jedediah Wilson, Erie, CO (US); Trent Guerrero, Parker, CO (US)

(21) Appl. No.: 18/752,590

(22) Filed: Jun. 24, 2024

Related U.S. Application Data
(60) Provisional application No. 63/522,751, filed on Jun. 23, 2023.

(51) Int. Cl. H01M 10/0565

(52) U.S. Cl. CPC H01M 10/0565; H01M 2300/0082

(57) ABSTRACT

Described herein are slurries comprising a solid electrolyte material and an ester solvent, and methods of making the same.

### CROSS-REFERENCE TO RELATED APPLICATION

This application is related to and claims priority under 35 U.S.C. § 119 (e) from U.S. Patent Application No. 63/522,751 filed Jun. 23, 2023, titled “Mixtures Containing a Solid Electrolyte and Methods of Making the Same,” the entire contents of which is incorporated herein by reference for all purposes.

### FIELD OF THE DISCLOSURE

The present disclosure is directed toward methods of preparing slurries containing a solid electrolyte material. Therefore, the disclosure relates to the fields of batteries, including solid-state batteries, electronics, chemistry, and materials science.

### BACKGROUND

When making solid-state electrochemical cells, each layer of the cell is often formed as a slurry, coated on a substrate, and then dried. To achieve a homogenous slurry with the proper rheological properties to coat the slurry on a substrate, the choice of solvent may be important. The choice of solvent is even more important in slurries that contain solid electrolytes, as the solvent may degrade the solid electrolyte material. In certain cases, the slurry should be used immediately after the slurry is formed to prevent substantial degradation of the electrolyte.

What is needed are methods for preparing slurries containing a solid electrolyte material, wherein the slurry achieves the desired rheological properties for coating the slurry on a substrate and subsequently drying the slurry while not degrading the solid electrolyte material, among other possible advantages and improvements.

It is with these observations in mind, among others, that various aspects of the present disclosure were conceived.

### SUMMARY

Provided herein are slurries for use in making electrochemical cell layers. The slurries comprise a solid electrolyte material and an ester solvent having the general formula:

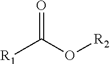

wherein R₁ is H, methyl, or ethyl, and wherein R₂ comprises an acyclic linear or branched hydrocarbon chain having five carbon atoms or more, and wherein the ester solvent has Hansen Solubility Parameters following the formula:

$${δ}^{2} = {( δ D )}^{2} + {( δ P )}^{2} + {( δ H )}^{2}$$

wherein δ is from about 16.4 MPa^{1/2} to about 18.2 MPa^{1/2}, δD is from about 15 MPa^{1/2} to about 18.2 MPa^{1/2}, δP is from greater than 4 MPa^{1/2} to about 6 MPa^{1/2}, and δH is from about 0 MPa^{1/2} to about 6 MPa^{1/2}. In some embodiments, δP is from greater than 4 MPa^{1/2} to about 5 MPa^{1/2}. In some embodiments, R₂ comprises an acyclic linear or branched hydrocarbon chain having from five carbon atoms up to twenty carbon atoms, such as from 5 carbon atoms up to ten carbon atoms. In some embodiments, R₂ comprises an acyclic, linear hydrocarbon chain containing five carbon atoms. In some examples, the ester solvent may comprise 2-ethyl-hexyl acetate, octyl acetate, or amyl propionate. The slurry may further comprise a binder, a hydrocarbon solvent, a conductive additive, an anode active material, a cathode active material, or any combination thereof.

Further provided herein is a method of preparing a slurry for use in making an electrochemical cell. The methods generally comprise combining a solid electrolyte material and an ester solvent having the general formula:

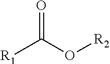

wherein R₁ is H, methyl, or ethyl, and wherein R₂ comprises an acyclic linear or branched hydrocarbon chain having five carbon atoms or more, and wherein the ester solvent has Hansen Solubility Parameters following the formula:

$${δ}^{2} = {( δ D )}^{2} + {( δ P )}^{2} + {( δ H )}^{2}$$

wherein δ is from about 16.4 MPa^{1/2} to about 18.2 MPa^{1/2}, δD is from about 15 MPa^{1/2} to about 18.2 MPa^{1/2}, δP is from greater than 4 MPa^{1/2} to about 6 MPa^{1/2}, and δH is from about 0 MPa^{1/2} to about 6 MPa^{1/2}. In some embodiments, δP is from greater than 4 MPa^{1/2} to about 5 MPa^{1/2}. In some embodiments, R₂ comprises an acyclic linear or branched hydrocarbon chain having from five carbon atoms up to twenty carbon atoms, such as from 5 carbon atoms up to ten carbon atoms. In some embodiments, R₂ comprises an acyclic, linear hydrocarbon chain containing five carbon atoms. In some examples, the ester solvent may comprise 2-ethyl-hexyl acetate, octyl acetate, or amyl propionate. In some embodiments, the combining step further comprises combining a binder, a conductive additive, a hydrocarbon solvent, an anode active material, or a cathode active material with the solid electrolyte material and the ester solvent.

### BRIEF DESCRIPTION OF THE FIGURES

The present disclosure may be understood by reference to the following detailed description taken in conjunction with the drawings briefly described below. It is noted that, for purposes of illustrative clarity, certain elements in the drawings may not be drawn to scale.

FIGS. 1A and 1B show example processes of the present disclosure for making solid-state electrodes.

FIG. 2 shows an apparatus for making solid-state electrochemical cell layers using the processes described herein.

FIG. 3 shows a chart of the conductivity (S/cm) of a solid electrolyte material suspended in slurries comprising various solvents after selected time periods.

### DETAILED DESCRIPTION

Before various aspects of the present invention are disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity and in another example, a numerical range of “about 50 mg/mL to about 80 mg/mL” should also be understood to provide support for the range of “50 mg/mL to 80 mg/mL.”

In this disclosure, the terms “including,” “containing,” and/or “having” are understood to mean comprising, and are open ended terms.

Described herein are slurries and methods for making slurries containing a solid electrolyte material for use in making an electrochemical cell, which in some cases may be considered a solid-state battery cell. The inventors surprisingly discovered that the use of particular ester solvents in preparing the slurry are particularly effective at forming a slurry having desired rheological properties while not degrading the solid electrolyte.

The slurry may comprise an ester solvent. The ester solvents of the present disclosure may have the general formula:

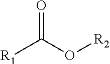

wherein R₁ comprises H or a hydrocarbon chain having one carbon atom (i.e., methyl or —CH₃) or two carbon atoms (i.e., ethyl or —CH₂CH₃), and wherein R₂ comprises an acyclic hydrocarbon chain having five carbon atoms or more. In some embodiments, R₂ comprises an acyclic branched hydrocarbon chain having five carbon atoms or more, wherein the acyclic branched hydrocarbon chain comprises one or more branches having one or more carbon atoms. In some aspects, R₂ comprises an acyclic linear or branched hydrocarbon chain having five carbon atoms or more, six carbon atoms or more, seven carbon atoms or more, or eight carbon atoms or more. In some embodiments, R₂ comprises an acyclic linear or branched hydrocarbon chain having five carbon atoms up to twenty carbon atoms, or five carbon atoms up to 10 carbon atoms. In some embodiments, R₂ comprises an acyclic linear or branched hydrocarbon chain having five carbon atoms, six carbon atoms, seven carbon atoms, or eight carbon atoms.

The ester solvent may have Hansen Solubility Parameters following the formula:

$${δ}^{2} = {( δ D )}^{2} + {( δ P )}^{2} + {( δ H )}^{2}$$

wherein δ is a Hansen solubility parameter, and δ is from about 16.4 MPa^{1/2} to about 18.2 MPa^{1/2}; δD is a dispersion energy parameter, and δD is from about 15 MPa^{1/2} to about 18.2 MPa^{1/2}; δP is a polar dipolar energy parameter, and δP is from about 0 MPa^{1/2} to about 6 MPa^{1/2}; and δH is a hydrogen bonding energy parameter, and δH is from about 0 MPa^{1/2} to about 6 MPa^{1/2}.

In some embodiments, δP is from about 2 MPa^{1/2} to about 6 MPa^{1/2}. In another embodiment, δP is from about 4 MPa^{1/2} to about 6 MPa^{1/2}. In other examples, δP is greater than 4 MPa^{1/2} to about 6 MPa^{1/2}. For example, 8P may be about 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, or about 6.0 MPa^{1/2}.

These ester solvents may be preferred in some cases, as they enhance the stability of the slurry (e.g., particles in the slurry remain in suspension for long periods of time after mixing) without degrading or reacting with the solid-state electrolyte material.

In some non-limiting exemplary embodiments, the ester solvent may include 2-ethyl-hexyl acetate (also referred to herein as 2EHA, wherein R₁=methyl and R₂=a branched hydrocarbon chain containing eight carbon atoms), amyl propionate (also known as pentyl propanoate, wherein R₁=ethyl and R₂=a linear hydrocarbon chain containing five carbon atoms), or a combination thereof. In other non-limiting exemplary embodiments, the ester solvent may include octyl acetate (wherein R₁=methyl and R₂=a linear hydrocarbon chain containing eight carbon atoms).

The slurry may further include a hydrocarbon solvent. The hydrocarbon solvent may include xylenes, toluene, benzene, heptane, octane, isoparaffins, or other hydrocarbon solvents known in the art and combinations thereof. The ester solvent and the hydrocarbon may be present in weight ratio from about 99:1 (ester:hydrocarbon) to about 60:40, such as from about 99:1 to about 90:10, about 99:1 to about 80:20, about 99:1 to about 70:30, about 99:1 to about 60:40, about 90:10 to about 60:40, about 80:20 to about 60:40, or about 70:30 to about 60:40.

The slurry may be an electrode slurry. The electrode slurry may comprise an electrode active material (such as an anode active material or a cathode active material), a conductive additive, a solid-state electrolyte material, a binder, and a solvent as described above. Alternatively, the slurry may be a separator slurry. The separator slurry may comprise a solid-state electrolyte material, a binder, a conductive additive, and a solvent as described above.

The slurry may further comprise a binder. In some embodiments, the binder may include fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVDF), polyhexafluoropropylene (PHFP), and polytetrafluoroethylene (PTFE), and binary copolymers such as copolymers of VdF and HFP such as poly (vinylene difluoride-hexafluoropropylene) copolymer (PVDF-HFP), and the like. In another embodiment, the binder may be one or more of a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, Poly (methacrylate) nitrile-butadiene rubber (PMMA-NBR) and the like. In a further embodiment, the binder may be one or more of an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), and mixtures thereof.

Preferably, the binder comprises a thermoplastic elastomer or a PVDF/PVDF-HFP derivative.

The binder may be present in the slurry in an amount from about 0% to about 40% by weight. For example, the binder may be present in the slurry in an amount from about 0% to about 5%, about 0% to about 10%, about 0% to about 15%, about 0% to about 20%, about 0% to about 25%, about 0% to about 30%, about 0% to about 35%, about 0% to about 40%, about 5% to about 40%, about 10% to about 40%, about 15% to about 40%, about 20% to about 40%, about 25% to about 40%, about 30% to about 40%, about 35% to about 40%, about 5% to about 15%, about 5% to about 20%, about 10% to about 15%, about 10% to about 20%, or about 15% to about 20% by weight.

The slurry may further comprise a conductive additive. The conductive additive helps to evenly distribute the charge density throughout the anode. The conductive additives may include metal powders, fibers, filaments, or any other material known to conduct electrons. The conductive additive may comprise a carbon-based conductive additive, such as carbon fiber, graphite, graphene, carbon black, conductive carbon, amorphous carbon, vapor grown carbon fiber (VGCF), carbon nanotubes, carbon nanowires, activated carbon, and combinations thereof.

In some embodiments, the conductive additive may be present in the slurry in an amount from about 0% to about 15% by weight. In some aspects, the conductive additive may be present in the slurry in an amount from about 0% to about 10%, or about 0% to about 5% by weight. In some additional aspects, the conductive additive may be present in the slurry in an amount of about 0%, 1%, 2%, 3%, 4%, 5%, 6%, 7%, 8%, 9%, 10%, 11%, 12%, 13%, 14%, or about 15% by weight. In an example embodiment, the conductive additive is present in the slurry in an amount from about 0% to about 5% by weight.

In some embodiments, the average particle size of the conductive additive may be from about 5 nm to about 1000 nm. In some aspects, the average particle size of the conductive additive may be about from 5 nm to about 100 nm, about 5 nm to about 200 nm, about 5 nm to about 300 nm, about 5 nm to about 400 nm, about 5 nm to about 500 nm, about 5 nm to about 600 nm, about 5 nm to about 700 nm, about 5 nm to about 800 nm, about 5 nm to about 900 nm, about 100 nm to about 1000 nm, about 200 nm to about 1000 nm, about 300 nm to about 1000 nm, about 400 nm to about 1000 nm, about 500 nm to about 1000 nm, about 600 nm to about 1000 nm, about 700 nm to about 1000 nm, about 800 nm to about 1000 nm, about 900 nm to about 1000 nm, about 100 nm to about 500 nm, or about 200 nm to about 400 nm. In some embodiments, the conductive additive may have a particle size of about 5 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, or about 1000 nm. In some examples, the conductive additive may have an average particle size of about 30 nm. The average particle size (e.g., D₅₀) may be determined through any method known to those having ordinary skill in the art.

The slurry further comprises a solid electrolyte material. The solid electrolyte material may comprise an oxide, oxysulfide, sulfide, halide, nitride, or any other solid electrolyte known in the art. In some preferred embodiments, the solid electrolyte materials may comprise a sulfide solid electrolyte material, i.e., a solid electrolyte having at least one sulfur component. In some embodiments, the one or more solid electrolytes may comprise one or more material combinations such as Li₂S—P₂S₅, Li₂S—P₂S₅—LiI, Li₂S—P₂S₅—GeS₂, Li2_{S}—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In). Halide solid electrolytes may have the structure Li-M-X, M is a metal element, and X is a halogen. These can be expressed by the generic formula LiₐM⁴⁺BN³⁺_{(1-β)}X_{Ω}Y_{(6-Ω)}, where: 0≤β≤1; 0≤Ω≤6; α=6−[(β*4)+(1−β)*3]; X and Y are a halogen such as F, Cl, Br, I; M is an element with an oxidation state of 4+ such as Ti, Zr, Hf, and Rf; and N is an element an oxidation state of 3+ such as Ga, In, and TI, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

In another embodiment, the solid electrolyte material may be one or more of a Li₃PS₄, Li₄P₂S₆, Li₂P₃S₁₁, Li₁₀GeP₂S₁₂, Li₁₀SnP₂S₁₂. In a further embodiment, the solid electrolyte material may be one or more of a Li₆PS₅Cl, Li₆PS₅Br, Li₆PS₅I or expressed by the formula Li_{7-y}PS_{6-y}X_{y} where “X” represents at least one halogen and/or at least one pseudo-halogen, and where 0<y≤2.0 and where the halogen may be one or more of F, Cl, Br, I, and the pseudo-halogen may be one or more of N, NH, NH₂, NO, NO₂, BF₄, BH₄, AlH₄, CN, and SCN. In yet another embodiment, the solid electrolyte material be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN.

The solid-state electrolyte material may be present in the slurry in an amount from greater than 0% to about 60% by weight; for example, the solid-state electrolyte may be present in the slurry in an amount from greater than 0% to about 10% by weight, greater than 0% to about 20% by weight, greater than 0% to about 30% by weight, greater than 0% to about 40% by weight, greater than 0% to about 50% by weight, about 10% to about 60% by weight, about 20% to about 60% by weight, about 30% to about 60% by weight, about 40% to about 60% by weight, or about 50% to about 60% by weight. In some aspects, the solid-state electrolyte material may be present in the slurry in an amount of about 5%, 10%, 15%, 20%, 25%, 30%, 35%, 40%, 45%, 50%, 55%, or 60% by weight of the anode layer. In an example embodiment, the solid-state electrolyte material is present in the slurry in an amount from about 35% to about 45% by weight.

In some embodiments, the average particle size of the solid-state electrolyte material may be from about 100 nm to about 50 μm. In some aspects, the average particle size of the conductive additive may be about from 200 nm to about 40 μm, about 500 nm to about 30 μm, about 600 nm to about 30 μm, about 700 nm to about 25 μm, about 800 nm to about 20 μm, about 800 nm to about 15 μm, about 800 nm to about 15 μm, about 800 nm to about 10 μm, about 800 nm to about 9 μm, about 100 nm to about 10 μm, about 200 nm to about 10 μm, about 400 nm to about 10 μm, about 600 nm to about 10 μm, about 800 nm to about 10 μm, about 1 μm to about 10 μm, about 1.25 μm to about 10 μm, about 1.5 μm to about 10 μm, about 2 μm to about 10 μm, about 2.25 μm to about 9 μm, or about 2.5 μm to about 8 μm. In some embodiments, the solid-state electrolyte material may have a particle size of about 100 nm, 200 nm, 300 nm, 400 nm, 500 nm, 600 nm, 700 nm, 800 nm, 900 nm, 1 μm, 2 μm, 3 μm, 4 μm, 5 μm, 6 μm, 8 μm, 10 μm, 15 μm, 25 μm, or about 50 μm. The average particle size (e.g., D₅₀) may be determined through any method known to those having ordinary skill in the art.

The slurry may further comprise an electrode active material, such as an anode active material or a cathode active material, either alone or in combination with the solid electrolyte material.

The electrode active material may be present in the slurry in an amount from about 30% to about 98% by weight. In some aspects, the electrode active material may be present in the slurry in an amount of about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 98%, about 40% to about 98%, about 45% to about 98%, about 50% to about 98%, about 55% to about 98%, about 60% to about 98%, about 65% to about 98%, about 70% to about 98%, about 75% to about 98%, about 80% to about 98%, about 85% to about 98%, about 90% to about 98%, about 40% to about 90%, about 40% to about 80%, about 40% to about 70%, about 40% to about 60%, about 40% to about 55%, about 40% to about 50%, or about 40% to about 45% by weight.

In some embodiments, the slurry may comprise an anode active material. The anode active material preferably is an inorganic material. The anode active material may comprise one or more inorganic materials such as silicon (Si), silicon alloys, tin (Sn), tin alloys, germanium (Ge), germanium alloys, graphite, Li₄Ti₅O₁₂ (LTO) or other known anode active materials and combinations thereof.

In some embodiments, the slurry may comprise a cathode active material. The cathode active material may include nickel-manganese-cobalt (“NMC”) which can be expressed as Li(NiₐCo_{b}Mn_{c})O₂(0<a<1, 0<b<1, 0<c<1, a+b+c=1) or, for example, NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂) or a combination thereof. In another embodiment, the cathode active material may comprise one or more of a coated or uncoated metal oxide, such as but not limited to V₂O₅, V₆O₁₃, MoO₃, LiCoO₂, LiNiO₂, LiMnO₂, LiMn₂O₄, LiNi_{1-Y}CO_{Y}O₂, LiCo_{1-Y}Mn_{Y}O₂, LiNi_{1-Y}Mn_{Y}O₂ (0≤Y<1), Li(NiₐCo_{b}Mn_{c})O₄(0<a<2, 0<b>2, 0<c<2, a+b+c=2), LiMn_{2-z}Ni₂O₄, LiMn_{2-z}CO_{z}O₄ (0<Z<2), LiCoPO₄, LiFePO₄, CuO, Li(NiₐCo_{b}Al_{c})O₂(0<a<1, 0<b<1, 0<c<1, a+b+c=1) or a combination thereof. In yet another embodiment, the cathode active material may comprise one or more of a coated or uncoated metal sulfide such as but not limited to titanium sulfide (TiS₂), molybdenum sulfide (MoS₂), iron sulfide (FeS, FeS₂), copper sulfide (CuS), and nickel sulfide (Ni₃S₂) or combinations thereof. In still further embodiments, the cathode active material may comprise elemental sulfur(S). In additional embodiments, the cathode active material may comprise one or more of a fluoride cathode active material such as but not limited to lithium fluoride (LiF), sodium fluoride (NaF), calcium fluoride (CaF₂), magnesium fluoride (MgF₂), nickel (II) fluoride (NiF₂), iron (III) fluoride (FeF₃), vanadium (III) fluoride (VF₃), cobalt (III) fluoride (CoF₃), chromium (III) fluoride (CrF₃), manganese (III) fluoride (MnF₃), aluminum fluoride (AlF₃), and zirconium (IV) fluoride (ZrF₄), or combinations thereof.

The slurry of the present disclosure may have a solids content from about 10% to less than 100%. For example, the slurry may have a solids content from about 10% to about 20%, about 10% to about 30%, about 10% to about 40%, about 10% to about 50%, about 10% to about 60%, about 10% to about 70%, about 10% to about 80%, about 10% to about 90%, about 10% to less than 100%, about 20% to less than 100%, about 30% to less than 100%, about 40% to less than 100%, about 50% to less than 100%, about 60% to less than 100%, about 70% to less than 100%, about 80% to less than 100%, about 90% to less than 100%, about 50% to about 90%, about 60% to about 90%, or about 70% to about 90%.

The electrode slurry may have a viscosity from about 20 cP to about 3000 cP measured at a shear rate of about 100 s⁻¹. For example, the electrode slurry may have a viscosity form about 20 cP to about 100 cP, about 20 cP to about 500 cP, about 20 cP to about 1000 cP, about 20 cP to about 1500 cP, about 20 cP to about 2000 cP, about 20 cP to about 2500 cP, about 20 cP to bout 3000 cP, about 100 cP to about 3000 cP, about 500 cP to about 3000 cP, about 1000 cP to about 3000 cP, about 1500 cP to about 3000 cP, about 2000 cP to about 3000 cP, or about 2500 cP to about 3000 cP. In some embodiments, the electrode slurry may have a viscosity of about 20 cP, 50 cP, 100 cP, 150 cP, 200 cP, 250 cP, 300 cP, 350 cP, 400 cP, 450 cP, 500 cP, 550 cP, 600 cP, 650 cP, 700 cP, 750 cP, 800 cP, 850 cP, 900 cP, 950 cP, 1000 cP, 1100 cP, 1200 cP, 1300 cP, 1400 cP, 1500 cP, 1600 cP, 1700 cP, 1800 cP, 1900 cP, 2000 cP, 2100 cP, 2200 cP, 2300 cP, 2400 cP, 2500 cP, 2600 cP, 2700 cP, 2800 cP, 2900 cP, or about 3000 cP measured at a shear rate of about 100 s⁻¹.

The slurry of the present disclosure may be formed by combining one or more of an ester solvent, a solid electrolyte material, a hydrocarbon solvent, a conductive additive, a binder, an anode active material, and a cathode active material. The combination may then be mixed to form a homogeneous slurry. Methods of combining and mixing are generally known to those having ordinary skill in the art.

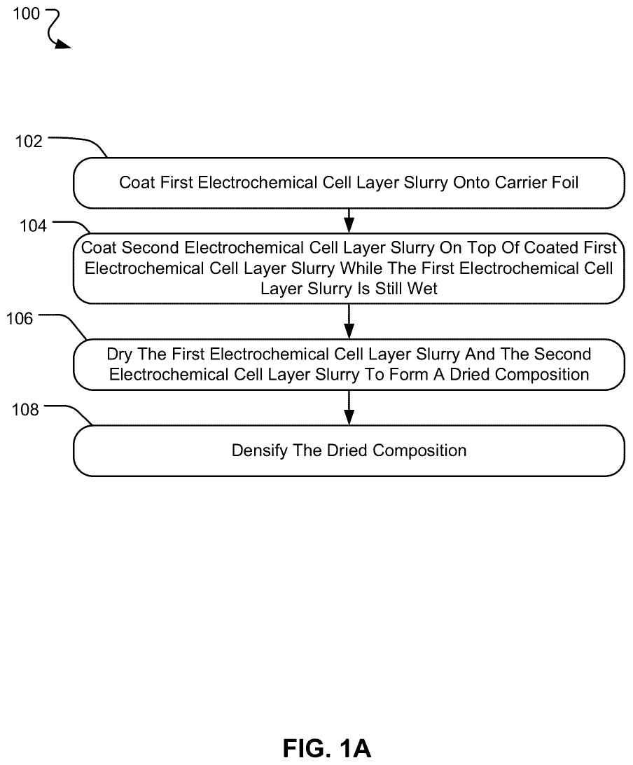

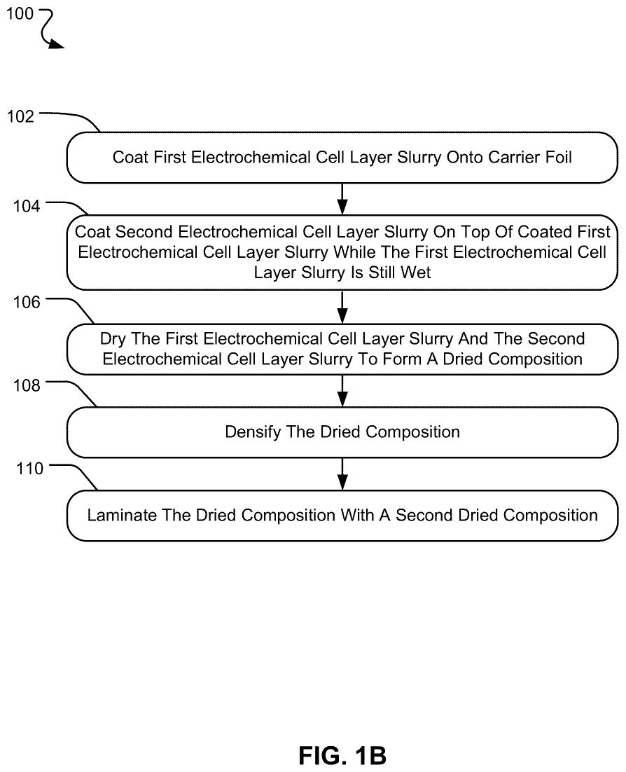

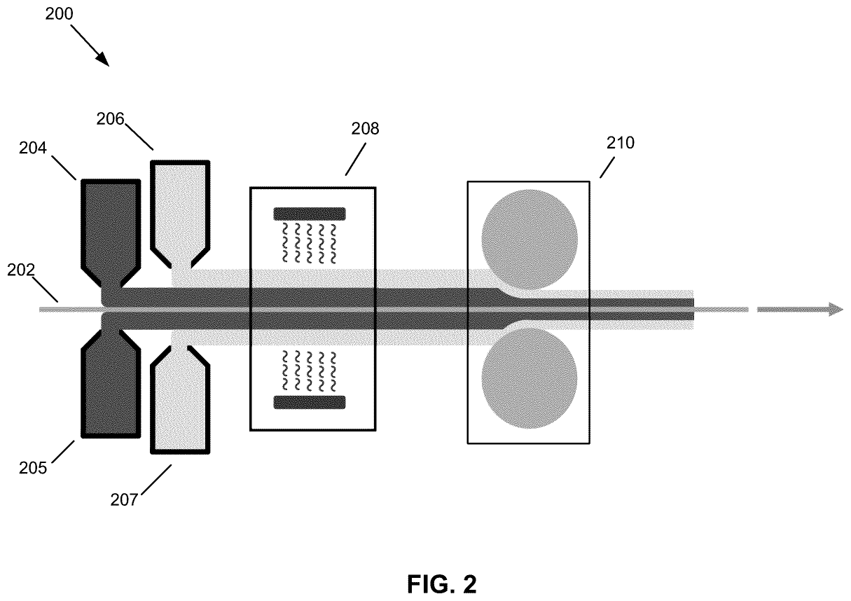

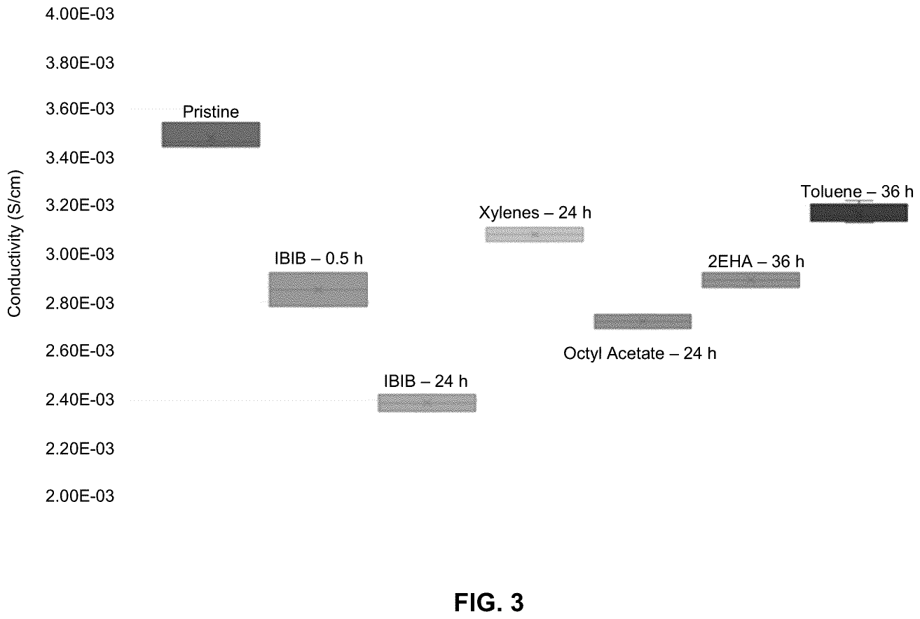

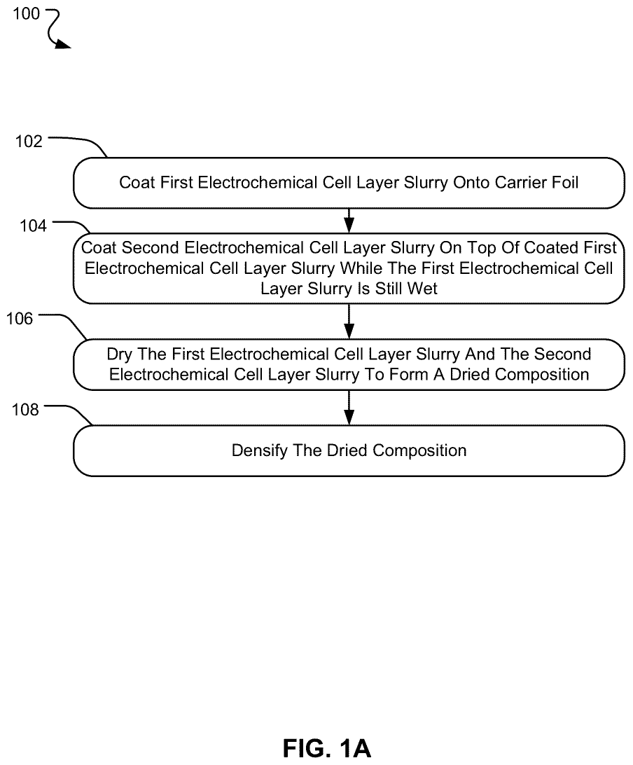

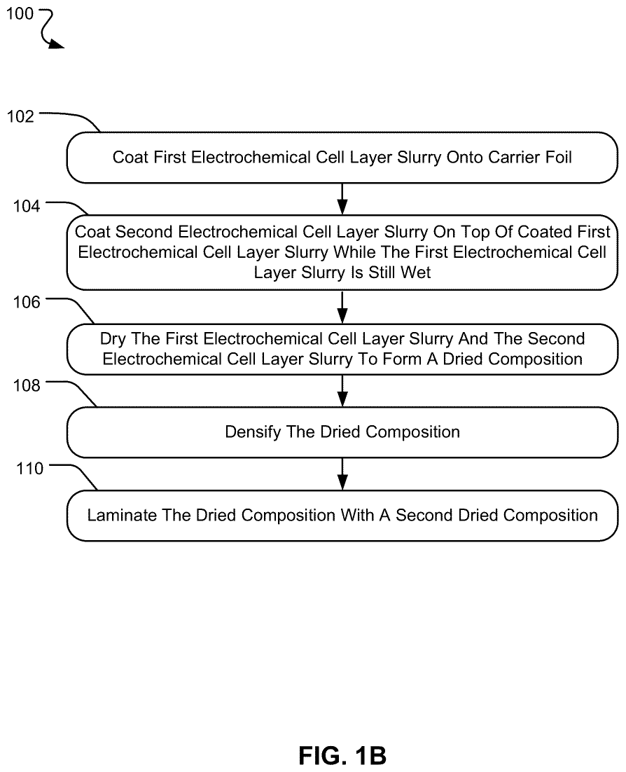

A process for preparing an electrochemical cell layer using a slurry of the present disclosure is shown in FIG. 1A. The process 100 begins at step 102 by coating the slurry onto a surface. The slurry may be any slurry described above, including an electrode slurry (e.g., an anode slurry or a cathode slurry), a separator slurry, or another slurry to make another electrochemical cell layer. The surface may comprise a carrier foil, a current collector, a dried electrochemical cell layer, or another surface. The coating may be accomplished by pouring the slurry onto a surface via gravity or by pumping the slurry onto the surface. The process may take place in ambient conditions, or may take place in an inert atmosphere such as nitrogen or argon. In some embodiments, the process may be conducted in an atmosphere comprising air and moisture. In other embodiments, the process may be conducted in an atmosphere comprising air and substantially no moisture (i.e., less than 1% humidity).

The slurry may be coated onto the surface at ambient temperature and pressure. In some aspects, the slurry may be coated onto the surface at a temperature up to the boiling point of the solvent system used in the slurry, or the slurry may be coated at cooler temperatures to limit vaporization of the solvent.

The process 100 continues at step 106 by drying the coated slurry to form a dried composition including at least one electrochemical cell layer. The drying at step 106 may occur at a temperature from about 15° C. to about 300° C. For example, the drying step 106 may occur at a temperature from about 15° C. to about 30° C., about 15° C. to about 50° C., about 15° C. to about 100° C., about 15° C. to about 150° C., about 15° C. to about 200° C., about 15° C. to about 250° C., about 15° C. to about 300° C., about 30° C. to about 300° C., about 50° C. to about 300° C., about 100° C. to about 300° C., about 150° C. to about 300° C., about 200° C. to about 300° C., or about 250° C. to about 300° C. In some embodiments, the drying step 106 may occur at a temperature of about 15° C., 20° C., 25° C., 30° C., 35° C., 40° C., 45° C., 50° C., 60° C., 70° C., 80° C., 90° C., 100° C., 125° C., 150° C., 175° C., 200° C., 225° C., 250° C., 275° C., or about 300° C.

After the drying step is completed, the amount of solvent left in the dried composition may range from 0.01% to 0% by weight of the composition.

If there is solvent remaining in the dried composition, the electrochemical performance of an electrochemical cell containing this dried composite may be negatively affected.

The process 100 continues at step 108 by densifying the dried composition. The composition may be densified through densification processes known to those having ordinary skill in the art, such as calendaring, linear densification, compaction, or compression. In preferred embodiments, the densifying may be accomplished via calendering.

The dried composition may have a density after densification from about 50% to about 99% of the theoretical density of the composition. The theoretical density is defined as the maximum density of the composition that could be achieved assuming there are no voids or contaminants. The density may be from about 50% to about 60%, about 50% to about 70%, about 50% to about 80%, about 50% to about 90%, about 50% to about 95%, about 50% to about 99%, about 60% to about 99%, about 70% to about 99%, about 80% to about 99%, about 90% to about 99%, or about 95% to about 99% of the theoretical density of the dried composition.

The dried composition may have a porosity from about 1% to about 70%. For example, the dried composition may have a porosity from about 1% to about 10%, about 1% to about 20%, about 1% to about 30%, about 1% to about 40%, about 1% to about 50%, about 1% to about 60%, about 1% to about 70%, about 10% to about 70%, about 20% to about 70%, about 30% to about 70%, about 40% to about 70%, about 50% to about 70%, or about 60% to about 70%. The porosity of the dried composition may be measured through techniques known in the art, such as through SEM imaging, TEM imaging, FIB-SEM imaging, confocal microscopy, gas adsorption, mercury porosimetry, helium pycnometry, or other methods known in the art.

In another embodiment, as shown in FIG. 1B, the process 100 may further comprise step 110 of laminating the dried composition with a second dried composition. The lamination may be accomplished by lamination methods generally well known in the art, such as by calendar rolling. The lamination may further increase the density of the dried composition. The second dried composition may or may not contain a binder concentration gradient.

The second dried composition may comprise a third electrochemical cell layer. The third electrochemical cell layer may be a separator layer, an electrode layer, or another layer electrochemical cell layer. The second dried composition may be produced using the processes described herein, or it may be produced using a different process. Generally, the second dried composition may be individually calendered separately from the first dried composition. The first dried composition and the second dried composition may be laminated together such that the second electrochemical cell layer is in contact with the third electrochemical cell layer; however, it will be appreciated by those having ordinary skill in the art that the first dried composition and the second dried composition may be laminated together such that the first electrochemical cell layer is in contact with the third electrochemical cell layer.

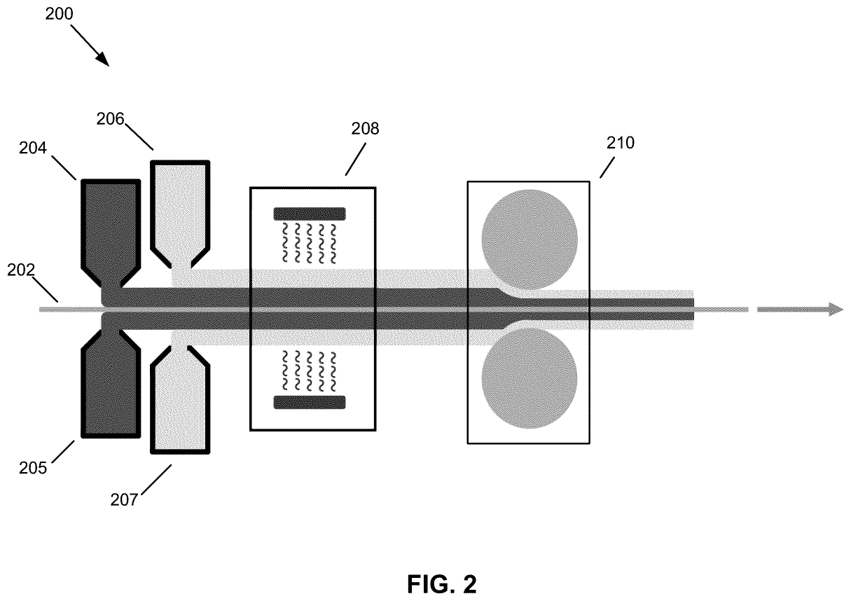

A depiction of an example process apparatus is shown in FIG. 2. Referring to FIG. 2, the apparatus 200 has two sides: Side A and Side B. The apparatus includes a surface 202, a first electrochemical cell layer slurry 204, a third electrochemical cell layer slurry 205, a second electrochemical cell layer slurry 206 a fourth electrochemical cell layer slurry 207, a drying module 208, and a densifying module 210. The two sides are oriented vertically, as shown in FIG. 2. Thus, the first electrochemical cell layer slurry 205 is deposited onto the surface 202 from below the surface 202. Likewise, the second electrochemical cell layer slurry 207 is deposited onto the surface 202 from below the surface 202. The inventors have surprisingly found that the slurries defined herein are capable of adhering to the surface 202 from below without falling or dripping from the surface 202. It will be appreciated by those having skill in the art that the process may be performed using only one of the sides; however, for efficiency and maximizing output, use of both sides is preferred.

The surface 202 may comprise a carrier foil or a current collector. The carrier foil or the current collector may comprise one or more of copper, aluminum, nickel, titanium, stainless steel, magnesium, iron, zinc, indium, germanium, silver, platinum, or gold. In some embodiments, the current collector may have a thickness from about 5 μm to about 10 μm. In some embodiments, the current collector includes a carbon coating. In preferred embodiments, the current collector comprises copper, nickel, and/or steel. Alternatively, the surface 402 may comprise a dried electrochemical cell layer.

The apparatus 200 shown in FIG. 2 may be used in a process for producing electrochemical cells as described herein. The process generally includes simultaneously coating a top side and a bottom side of a two-sided surface with a first wet electrode slurry and a second wet electrode slurry, respectively; and, simultaneously coating a first separator slurry and a second separator slurry on each of the respective top and bottom coated wet electrode slurry resulting in two parallel regions of wet-on-wet areas of contact between electrode and separator to physically form two neighboring electrochemical cell portions of a solid state battery. The first and second wet electrode slurries may each be any of the electrode slurries described herein. The first and second separator slurries may each be any of the separator slurries described herein. The two-sided surface may be any of the surfaces provided herein.

### Enumerated Embodiments

Embodiment 1: A slurry comprising a solid electrolyte material and an ester solvent having the general formula:

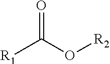

wherein R₁ is H, methyl, or ethyl, and wherein R₂ comprises an acyclic linear or branched hydrocarbon chain having five carbon atoms or more.

Embodiment 2: The slurry of embodiment 1, further comprising a binder.

Embodiment 3: The slurry of embodiment 1 or embodiment 2, further comprising a hydrocarbon solvent.

Embodiment 4: The slurry of any one of embodiments 1-3, further comprising a conductive additive.

Embodiment 5: The slurry of any one of embodiments 1-4, further comprising a cathode active material.

Embodiment 6: The slurry of any one of embodiments 1-5, further comprising an anode active material.

Embodiment 7: The slurry of any one of embodiments 1-6, wherein R₂ comprises an acyclic linear or branched hydrocarbon chain having from five carbon atoms up to twenty carbon atoms.

Embodiment 8: The slurry of any one of embodiments 1-7, wherein R₂ comprises an acyclic linear or branched hydrocarbon chain having from five carbon atoms up to ten carbon atoms.

Embodiment 9: The slurry of any one of embodiments 1-8, wherein R₂ comprises an acyclic, linear hydrocarbon chain containing eight carbon atoms.

Embodiment 10: The slurry of any one of embodiments 1-9, wherein the ester solvent has Hansen Solubility Parameters following the formula:

$${δ}^{2} = {( δ D )}^{2} + {( δ P )}^{2} + {( δ H )}^{2}$$

wherein δ is a Hansen solubility parameter, and δ is from about 16.4 MPa^{1/2} to about 18.2 MPa^{1/2}; δD is a dispersion energy parameter, and δD is from about 15 MPa^{1/2} to about 18.2 MPa^{1/2}; δP is a polar dipolar energy parameter, and δP is from about 0 MPa^{1/2} to about 6 MPa^{1/2}; and δH is a hydrogen bonding energy parameter, and δH is from about 0 MPa^{1/2} to about 6 MPa^{1/2}.

Embodiment 11: The slurry of any one of embodiments 1-10, wherein the ester solvent comprises amyl propionate.

Embodiment 12: An electrochemical cell layer prepared using a slurry of any one of embodiments 1-11.

Embodiment 13: An electrochemical cell comprising the electrochemical cell layer of embodiment 12.

Embodiment 14: A method of preparing a slurry for use in making an electrochemical cell, the method comprising combining a solid electrolyte material and an ester solvent having the general formula:

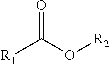

wherein R₁ comprises H, methyl, or ethyl, and wherein R₂ comprises an acyclic linear or branched hydrocarbon chain having five carbon atoms or more; and

mixing the combination to form the slurry.

Embodiment 15: The method of embodiment 14, wherein the combining step further comprises combining a binder with the solid electrolyte material and the ester solvent.

Embodiment 16: The method of embodiment 14 or 15, wherein the combining step further comprises combining a conductive additive with the solid electrolyte material and the ester solvent.

Embodiment 17: The method of any one of embodiments 14-16, wherein the combining step further comprises combining a hydrocarbon solvent with the solid electrolyte material and the ester solvent.

Embodiment 18: The method of any one of embodiments 14-17, wherein the combining step further comprises combining a anode active material with the solid electrolyte material and the ester solvent.

Embodiment 19: The method of any one of embodiments 14-18, wherein the combining step further comprises combining a cathode active material with the solid electrolyte material and the ester solvent.

Embodiment 20: The method of any one of embodiments 14-19, wherein R₂ comprises an acyclic linear or branched hydrocarbon chain having from five carbon atoms up to twenty carbon atoms.

Embodiment 21: The method of any one of embodiments 14-20, wherein R₂ comprises an acyclic linear or branched hydrocarbon chain having from five carbon atoms up to ten carbon atoms.

Embodiment 22: The method of any one of embodiments 14-21, wherein R₂ comprises an acyclic, linear hydrocarbon chain containing eight carbon atoms.

Embodiment 23: The method of any one of embodiments 14-22, wherein the ester solvent comprises amyl propionate.

Embodiment 24: The method of any one of embodiments 14-23, wherein the ester solvent has Hansen Solubility Parameters following the formula:

$${δ}^{2} = {( δ D )}^{2} + {( δ P )}^{2} + {( δ H )}^{2}$$

wherein δ is a Hansen solubility parameter, and δ is from about 16.4 MPa^{1/2} to about 18.2 MPa^{1/2}; δD is a dispersion energy parameter, and δD is from about 15 MPa^{1/2} to about 18.2 MPa^{1/2}; δP is a polar dipolar energy parameter, and δP is from about 0 MPa^{1/2} to about 6 MPa^{1/2}; and δH is a hydrogen bonding energy parameter, and δH is from about 0 MPa^{1/2} to about 6 MPa^{1/2}.

### EXAMPLES

Examples have been set forth below for the purpose of illustration and to describe certain specific embodiments of the disclosure. However, the scope of the claims is not to be in any way limited by the examples set forth herein. Various changes and modifications to the disclosed embodiments will be apparent to those skilled in the art and such changes and modifications including, without limitation, those relating to the chemical structures, substituents, derivatives, formulations, or methods of the disclosure may be made without departing from the spirit of the disclosure and the scope of the appended claims. Definitions of the variables in the structures in the schemes herein are commensurate with those of corresponding positions in the formulae presented herein.

### Stability of a Solid Electrolyte Material in Various Solvents

### Example 1

2.5 grams of a solid-state sulfide electrolyte material having an ionic conductivity of 1.8 mS/cm was placed in glass vial along with 5 mL of butyl formate. The electrolyte material was mixed in the solvent for 1 hour, after which, the electrolyte material was removed from the vial and the solvent was evaporated. Once the solid-state sulfide electrolyte material was fully dried, the ionic conductivity of the resulting material was 0.441 mS/cm, which is 24% of the original ionic conductivity.

### Example 2

Example 2 was conducted in the same manner as Example 1 except hexyl formate was used as the solvent. The ionic conductivity of the resulting electrolyte material was 0.480 mS/cm, which is 27% of the original ionic conductivity.

### Example 3

Example 3 was conducted in the same manner as Example 1 except amyl acetate was used as the solvent. The ionic conductivity of the resulting electrolyte material was 1.38 mS/cm, which is 77% of the original ionic conductivity.

### Example 4

Example 4 was conducted in the same manner as Example 1 except isoamylacetate used was as the solvent. The ionic conductivity of the resulting electrolyte material was 1.3 mS/cm, which is 72% of the original ionic conductivity.

### Example 5

Example 5 was conducted in the same manner as Example 1 except hexyl acetate was used as the solvent. The ionic conductivity of the resulting electrolyte material was 1.38 mS/cm, which is 77% of the original ionic conductivity.

### Example 6

Example 6 was conducted in the same manner as Example 1 except nonyl acetate was used as the solvent. The ionic conductivity of the resulting electrolyte material was 1.22 mS/cm, which is 68% of the original ionic conductivity.

### Example 7

Example 7 was conducted in the same manner as Example 1 except octyl acetate was used as the solvent. The ionic conductivity of the resulting electrolyte material was 1.38 mS/cm, which is 77% of the original ionic conductivity.

### Example 8

Example 8 was conducted in the same manner as Example 1 except 2-ethyl hexyl acetate was used as the solvent. The ionic conductivity of the resulting electrolyte material was 1.37 mS/cm, which is 76% of the original ionic conductivity.

### Example 9

Example 9 was conducted in the same manner as Example 1 except butyl propionate was used as the solvent. The ionic conductivity of the resulting electrolyte material was 1.34 mS/cm, which is 74% of the original ionic conductivity.

### Example 10

Example 10 was conducted in the same manner as Example 1 except pentyl propionate was used as the solvent. The ionic conductivity of the resulting electrolyte material was 1.48 mS/cm which is 82% of the original ionic conductivity.

### Example 11

Example 11 was conducted in the same manner as Example 1 except hexyl propionate was used as the solvent. The ionic conductivity of the resulting electrolyte material was 1.47 mS/cm, which is 82% of the original ionic conductivity.

### Example 12

Example 12 was conducted in the same manner as Example 1 except isobutyl isobutyrate was used as the solvent. The ionic conductivity of the resulting electrolyte material was 1.29 mS/cm, which is 72% of the original ionic conductivity.

The solvents used in Examples 1-12 are described in Table 1 below.

TABLE 1

| | | | | | IC | | | |
|---|---|---|---|---|---|---|---|---|
| | | R1 # of | R2 # of | IC | Retention | | | |
| | Solvent | Carbons | Carbons | (mS/cm) | (%) | dP | dD | dH |
| Example 1 | Butyl Formate | 0 | 4 | 0.441 | 24% | 6.5 | 15.7 | 9.2 |
| Example 2 | Hexyl Formate | 0 | 6 | 0.48 | 27% | | | |
| Example 3 | Amyl Acetate | 1 | 5 | 1.38 | 77% | 3.3 | 15.8 | 6.1 |
| Example 4 | Isoamyl Acetate | 1 | 5 | 1.3 | 72% | 3.1 | 15.3 | 7 |
| Example 5 | Hexyl Acetate | 1 | 6 | 1.38 | 77% | 2.9 | 15.8 | 5.9 |
| Example 6 | Nonyl Acetate | 1 | 9 | 1.22 | 68% | | | |
| Example 7 | Octyl Acetate | 1 | 8 | 1.38 | 77% | 2.9 | 15.8 | 5.1 |
| Example 8 | 2-Ethyl Hexyl | 1 | 8 | 1.37 | 76% | 2.8 | 15.1 | 5.8 |
| | Acetate | | | | | | | |
| Example 9 | Butyl Propionate | 2 | 4 | 1.34 | 74% | 5.5 | 15.7 | 5.9 |
| Example 10 | Pentyl | 2 | 5 | 1.48 | 82% | 5.2 | 15.8 | 5.7 |
| | Propionate | | | | | | | |
| Example 11 | Hexyl | 2 | 6 | 1.47 | 82% | 5.2 | 15.7 | 5.6 |
| | Propionate | | | | | | | |
| Example 12 | Isobutyl | 3 | 3 | 1.29 | 72% | 2.8 | 15.1 | 5.8 |
| | Isobutyrate | | | | | | | |

### Results and Discussion

A notable difference arose when comparing the compatibility of a solid state sulfide electrolyte and a solvent, where the solvent may be expressed by the following formula:

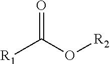

When the solvent has less than 1 carbon in the R₁ position, a substantial drop in ionic conductivity (IC) retention was observed even when the number of carbons in the R₂ position is 4 or greater. This is shown by Example 1 and Example 2, where butyl formate from Example 1 has 0 carbons in the R₁ position and 4 carbons in the R₂ position and hexyl formate from Example 2 has 0 carbons in the R₁ position and 6 carbons in the R₂ position. The ionic conductivity of the solid-state sulfide electrolyte exposed to these solvents fell by 76% and 73% respectively. This suggests the importance of having the number of carbons in the R₁ position greater than 0. From Example 12, it was observed that when using a solvent with 3 carbons in the R₁ position and 3 carbons in the R₂ position, the ionic conductivity of the solid-state sulfide electrolyte after being exposed to this solvent falls by 28%. This suggests that using a solvent where the number of carbons in the R₁ position is greater than 0 but less than 3 may be ideal.

However, when a solvent is used where the number of carbons in the R₁ position is greater than 0 but less than 3 and the number of carbons in the R₂ position is larger than 8, a negative impact on the ionic conductivity was observed as shown by Example 6. Nonyl acetate has 1 carbon in the R₁ position and 9 carbons in the R₂ position and, from Example 6, it was observed that the ionic conductivity of the electrolyte material after being exposed to this solvent fell by 32%. Moreover, when a solvent is used where the number of carbons in the R₁ position is position is greater than 0 but less than 3 and the number of carbons in the R₂ position is less than 5, a negative impact on the ionic conductivity was observed as shown by Example 9. Butyl propionate has 2 carbons in the R₁ position and 4 carbons in the R₂ position and, from Example 9, it was observed that the Ionic Conductivity of the electrolyte material after being exposed to this solvent fell by 26%. This in combination with Example 6 surprisingly suggests that a solvent having more than 4 but less than 9 carbons in the R₂ position may have ideal compatibility with solid state sulfide electrolytes.

An even more surprising result was shown when comparing solvents that have the ideal number of carbons in the R₁ and R₂ position as described in the previous paragraph and each solvent's specific Hansen Solubility Parameters. It was found that by selecting a solvent with specific Hansen Solubility Parameters, a further improvement in solid state sulfide electrolyte compatibility could be made. For example, isoamyl acetate from Example 4 has 1 carbon in the R₁ position and 5 carbons in the R₂ position, and amyl propionate from Example 10 has 2 carbons in the R₁ position and 5 carbons in the R₂ position, which are within the ideal range as described in the previous paragraph. However, for Example 4, the polar dipolar energy parameter (dP) for the solvent is below 4 while for Example 10, the polar dipolar energy parameter (dP) for the solvent is above 4. This difference results in the ionic conductivity retention for Example 10 being 82% while the ionic conductivity retention for Example 4 is only 72%.

### Example 13

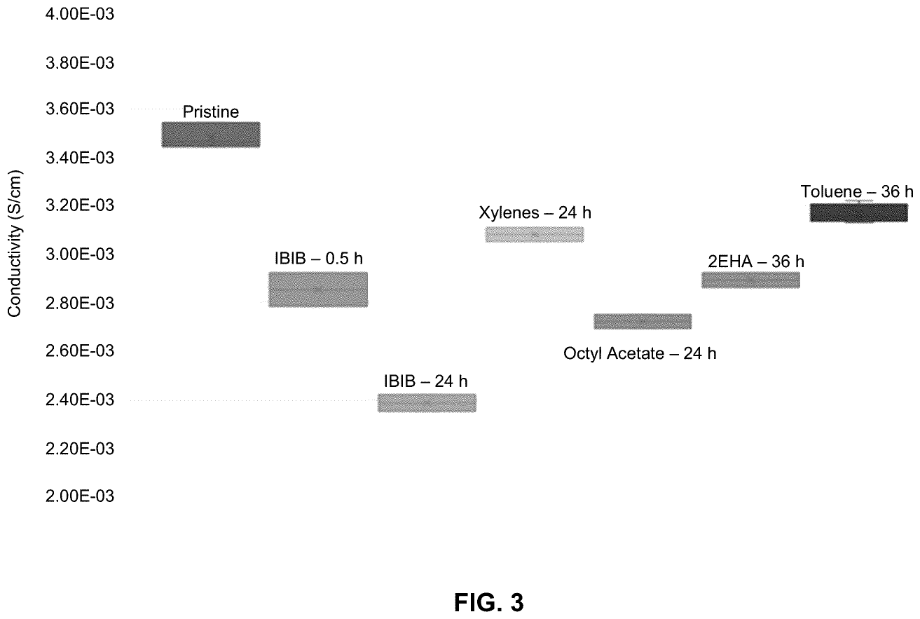

A solid electrolyte material was incorporated into slurries comprising the following solvents: isobutyl isobutyrate (IBIB), xylenes, octyl acetate, 2EHA, and toluene. The conductivity of the solid electrolyte material was measured prior to incorporation into the slurry (pristine). The conductivities of the solid electrolyte material after suspension in each of the solvents for selected time periods is shown in FIG. 3.

As shown in FIG. 3, some esters such as IBIB can degrade the solid electrolyte material within minutes of interaction. When the solid electrolyte material was left in the IBIB solvent for 24 hours, the ionic conductivity fell by upwards of about 32%. When the same electrolyte material was left in octyl acetate for 24 hours, the ionic conductivity fell by about 22%. When the same electrolyte material was left in 2EHA for 36 hours (50% longer), the ionic conductivity decreased by 18%. When the same electrolyte material was left in toluene for the same amount of time, 36 hours, the ionic conductivity of the electrolyte material decreased by less than 10%. Similarly, the same electrolyte material was left in xylenes for 24 hours, the ionic conductivity of the electrolyte material decreased by less than 10%. This shows how stable electrolyte materials can be in hydrocarbon-based solvents such as xylenes and toluene. As such, if a blend of solvents is used to make slurries where one solvent is a solvent of the present disclosure, selecting hydrocarbon-based solvents as one or more additional solvents of that blend may be ideal.

What is claimed is:

1. A slurry comprising a solid electrolyte material and an ester solvent having the general formula: 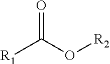
wherein R₁ is H, methyl, or ethyl, and wherein R₂ comprises an acyclic linear or branched hydrocarbon chain having five carbon atoms or more.

2. The slurry of claim 1, further comprising a binder.

3. The slurry of claim 1, further comprising a hydrocarbon solvent.

4. The slurry of claim 1, further comprising a conductive additive.

5. The slurry of claim 1, further comprising a cathode active material.

6. The slurry of claim 1, further comprising an anode active material.

7. The slurry of claim 1, wherein R₂ comprises an acyclic linear or branched hydrocarbon chain having from five carbon atoms up to twenty carbon atoms.

8. The slurry of claim 1, wherein R₂ comprises an acyclic linear or branched hydrocarbon chain having from five carbon atoms up to 10 carbon atoms.

9. The slurry of claim 1, wherein R₂ comprises an acyclic, linear hydrocarbon chain containing eight carbon atoms.

10. The slurry of claim 1, wherein the ester solvent has Hansen Solubility Parameters following the formula:
$${δ}^{2} = {( δ D )}^{2} + {( δ P )}^{2} + {( δ H )}^{2}$$
wherein δ is a Hansen solubility parameter, and δ is from about 16.4 MPa^{1/2} to about 18.2 MPa^{1/2}; δD is a dispersion energy parameter, and δD is from about 15 MPa^{1/2} to about 18.2 MPa^{1/2}; δP is a polar dipolar energy parameter, and δP is from about 0 MPa^{1/2} to about 6 MPa^{1/2}; and δH is a hydrogen bonding energy parameter, and δH is from about 0 MPa^{1/2} to about 6 MPa^{1/2}.

11. The slurry of claim 1, wherein the ester solvent comprises amyl propionate.

12. An electrochemical cell layer prepared using a slurry of claim 1.

13. An electrochemical cell comprising the electrochemical cell layer of claim 12.

14. A method of preparing a slurry for use in making an electrochemical cell, the method comprising combining a solid electrolyte material and an solvent having the general formula: 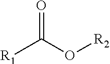
wherein R₁ comprises H, methyl, or ethyl, and wherein R₂ comprises an acyclic linear or branched hydrocarbon chain having five carbon atoms or more; and
mixing the combination to form the slurry.

15. The method of claim 14, wherein the combining step further comprises combining a binder with the solid electrolyte material and the ester solvent.

16. The method of claim 14, wherein the combining step further comprises combining a conductive additive with the solid electrolyte material and the ester solvent.

17. The method of claim 14, wherein the combining step further comprises combining a hydrocarbon solvent with the solid electrolyte material and the ester solvent.

18. The method of claim 14, wherein the combining step further comprises combining a anode active material with the solid electrolyte material and the ester solvent.

19. The method of claim 14, wherein the combining step further comprises combining a cathode active material with the solid electrolyte material and the ester solvent.

20. The method of claim 14, wherein R₂ comprises an acyclic linear or branched hydrocarbon chain having from five carbon atoms up to twenty carbon atoms.

21. The method of claim 14, wherein R₂ comprises an acyclic linear or branched hydrocarbon chain having from five carbon atoms up to 10 carbon atoms.

22. The method of claim 14, wherein R₂ comprises an acyclic, linear hydrocarbon chain containing eight carbon atoms.

23. The method of claim 14, wherein the solvent comprises amyl propionate.

24. The method of claim 14, wherein the ester solvent has Hansen Solubility Parameters following the formula:
$${δ}^{2} = {( δ D )}^{2} + {( δ P )}^{2} + {( δ H )}^{2}$$
wherein δ is a Hansen solubility parameter, and δ is from about 16.4 MPa^{1/2} to about 18.2 MPa^{1/2}; δD is a dispersion energy parameter, and δD is from about 15 MPa^{1/2} to about 18.2 MPa^{1/2}; δP is a polar dipolar energy parameter, and SP is from about 0 MPa^{1/2} to about 6 MPa^{1/2}; and δH is a hydrogen bonding energy parameter, and δH is from about 0 MPa^{1/2} to about 6 MPa^{1/2}.
